(19) United States
(12) Patent Application Publication
(10) Pub. No.: US 2009/0006556 A1
(43) Pub. Date: Jan. 1, 2009

(54) ASSIGNING TAGS TO NETWORK ADDRESSES FOR SUBSEQUENT RETRIEVAL OF THE NETWORK ADDRESSES

(76) Inventors: Anjana Agarwal, Wheaton, IL (US); David S. Benco, Winfield, IL (US); Byron J. Williams, Chicago, IL (US)

Correspondence Address: DUFT BORNSEN & FISHMAN, LLP, 1526 SPRUCE STREET, SUITE 302, BOULDER, CO, 80302, US

(21) Appl. No.: 11/768,840

(22) Filed: Jun. 26, 2007

(51) Int. Cl. G06F 15/16

(52) U.S. Cl. 709/206

(57) ABSTRACT

Systems and methods are provided for assigning a tag, such as a short name, to a network address of a web page for ease in subsequent retrieval of the web page. A user of a browser application may enter a tag responsive to which the browser application associates the tag with a network address of a web page. The browser application then transmits the tag and the network address to a tag server that stores the tag as assigned to the network address. At a subsequent time, a user may enter the tag into a browser application to retrieve the network address that is associated with the tag. The browser application transmits the tag to the tag server to retrieve the network address associated with the tag. The browser application may then display the web page that is associated with the retrieved network address.

### BACKGROUND OF THE INVENTION

1. Field of the Invention

The invention is related to the field of packet networks and, in particular, to assigning a tag, such as a short meaningful name, to a network address of a web page so that the web page can be more easily retrieved at a later time.

2. Statement of the Problem

A web browser is a software application that enables a user to display and interact with text, images, and other information typically located on a web page at a website on the Internet or a local area network (e.g., an enterprise network). The web browser is adapted to access the web pages through Universal Resource Locators (URL) that are assigned to the web pages. A URL is an alphanumeric string that is associated with an actual EP address for a web page. For instance, a web page for Company A may have a URL of “www.CompanyA.com”, which is associated with the IP address for the web page for Company A. A Domain Name Server (DNS) is typically used to translate the URL to the actual IP address. A user may enter this URL for Company A into the web browser, responsive to which the web browser issues the proper HTTP request to retrieve the web page, and displays its contents to the user.

One problem with accessing web pages and navigating the Internet is that URLs may be lengthy (e.g., 50-100 characters), may include words or terms that are difficult to spell or to understand, may include special characters, or may otherwise be complex. For instance, another URL associated with a web page for advertising jobs for Company A may be “www.CompanyA.com/portal/!ut/p/kcxml/04_Sj95Pykssy0xPLMn”. URLs such as this may be difficult for a user to remember and may be difficult for a user to enter into his/her web browser to retrieve the web page. Further, conveying lengthy and complex URLs such as this to other users may be difficult and prone to errors. For instance, assume User A wants to convey the above URL for Company A to User B. One way of conveying the URL is for User A to speak each character of the URL to User B. This process is prone to errors both in the reading of the URL by User A and in the entering of the URL by User B into his/her web browser. Another way of conveying the URL is for User A to send the URL through some electronic means, such as email, text message, etc. Unfortunately, User B may still have to enter the URL manually into his/her web browser or perform a cut and paste operation to enter the URL into the web browser. These ways of entering a lengthy and complex URL into a web browser are particularly a problem for mobile devices, where the user interfaces are generally small and slow to use, and where cut and paste type operations are not supported.

Similar problems exist for other network addresses, such as an IP address, that are lengthy, complex, or difficult to remember.

### SUMMARY OF THE SOLUTION

Embodiments of the invention solve the above and other related problems by assigning tags to network addresses, such as URLs, where the tags are alphanumeric strings that are easier for users to remember. For instance, a user may assign the tag “JOBS” to the URL for the job advertising web page for Company A. This tag is much easier to remember, enter into a web browser, and convey to other users than the lengthy and complex URL illustrated above for the web page.

According to the embodiments described herein, a user of a browser application may enter a tag which the browser application associates with a network address of a web page. The tag is a short name or phrase that is typically easier to remember than the actual network address. The browser application then generates a tag assignment message that includes the network address and the tag assigned to the network address, and transmits the tag assignment message to a tag server.

The tag server receives the tag assignment message, and processes the tag assignment message to determine if the tag assigned to the network address by the user is assigned to another network address. If the tag is not assigned to another network address, then the tag server stores the tag assigned to the network address in the memory.

At a subsequent time, a user of the same browser application or a different browser application receives input requesting a network address that was assigned to a tag. The browser application then generates a tag retrieval message that includes the tag, and transmits the tag retrieval message to the tag server to retrieve the network address from the tag server that was assigned to the tag. The tag server receives the tag retrieval message, and identifies the network address in the memory that is assigned to the tag. The tag server then generates a tag response message that includes the network address assigned to the tag, and transmits the tag response message to the browser application for display of the web page associated with the network address.

By assigning a tag to a network address of a web page, a user is able to create an easy to remember name for the network address. The user may then enter the tag at a later time into a browser application to retrieve the web page, and the user does not have to remember a lengthy and complex URL or bother with entering a lengthy URL into the browser application. Further, if the user wants to refer other users to the web page, the user merely has to convey the tag to the other users, and the other users will be able to retrieve the web page simply by knowing the tag that was assigned to the network address of the web page. The assignment of tags greatly simplifies the process of accessing web pages and navigating the Internet.

The invention may include other exemplary embodiments described below.

### DESCRIPTION OF THE DRAWINGS

The same reference number represents the same element or same type of element on all drawings.

FIG. 1 illustrates a communication network in an exemplary embodiment of the invention.

FIG. 2 is a flow chart illustrating a method of operating a browser application to assign a tag to a network address in an exemplary embodiment of the invention.

FIG. 3 is a flow chart illustrating a method of operating a tag server to assign a tag to a network address in an exemplary embodiment of the invention.

FIG. 4 is a flow chart illustrating a method of operating a browser application to retrieve a network address assigned to a tag in an exemplary embodiment of the invention.

FIG. 5 is a flow chart illustrating a method of operating a tag server to retrieve a network address that is assigned to a tag in an exemplary embodiment of the invention.

FIG. 6 illustrates the browser interface of a browser application for assigning a tag in an exemplary embodiment of the invention.

FIG. 7 illustrates the browser interface of a browser application for retrieving a URL in an exemplary embodiment of the invention.

FIG. 8 illustrates a browser application displaying the web page for Company A in an exemplary embodiment of the invention.

### DETAILED DESCRIPTION OF THE INVENTION

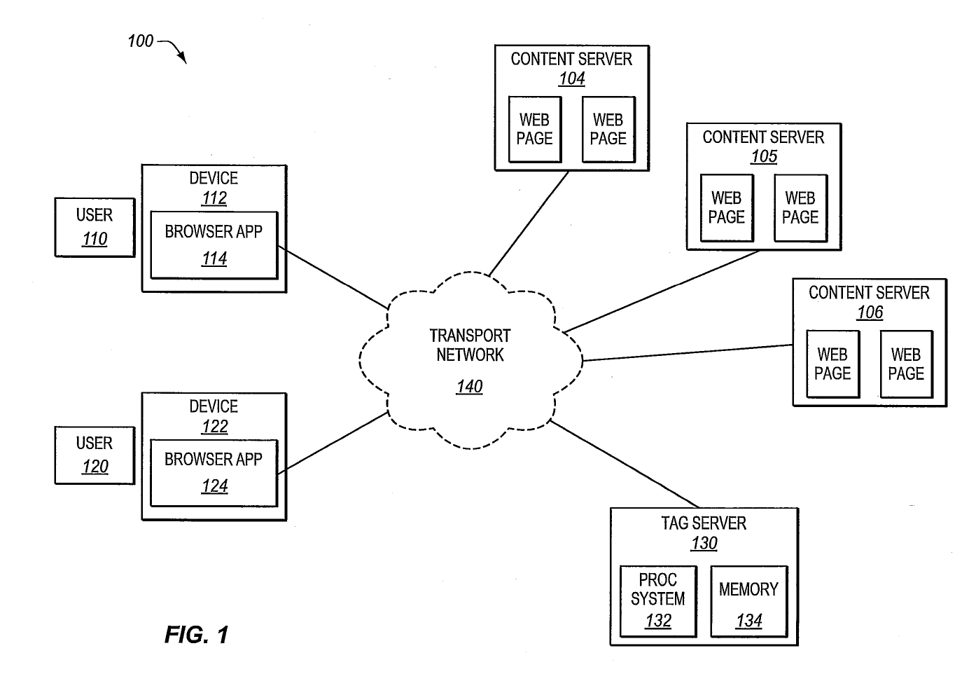

FIGS. 1-8 and the following description depict specific exemplary embodiments of the invention to teach those skilled in the art how to make and use the invention. For the purpose of teaching inventive principles, some conventional aspects of the invention have been simplified or omitted. Those skilled in the art will appreciate variations from these embodiments that fall within the scope of the invention. Those skilled in the art will appreciate that the features described below can be combined in various ways to form multiple variations of the invention. As a result, the invention is not limited to the specific embodiments described below, but only by the claims and their equivalents.

FIG. 1 illustrates a communication network 100 in an exemplary embodiment of the invention. Communication network 100 may comprise an Internet Protocol (IP) network or another type of packet based network. Communication network 100 includes a plurality of content servers 104-106 connected to a transport network 140. Content servers 104-106 comprise any systems or servers adapted to host a website and/or store one or more web pages (or content pages). A web page comprises any content file or content resource that can be accessed over communication network 100 by a browser application. The web pages may be in HTML format, XHTML format, or another suitable format. Although only three content servers are shown in FIG. 1, communication network 100 may include multiple other content servers.

FIG. 1 also illustrates user 110 that is operating device 112 to access web pages in communication network 100. Device 112 comprises any type of device adapted to execute a browser application 114. Device 112 may comprise a mobile device, such as a cell phone, a PDA, etc, or may comprise a computer or another type of processing device. Browser application 114 comprises any software application that enables a user to display and interact with text, images, and other information typically located on a web page at a website on communication network 100. FIG. 1 also illustrates user 120 that is operating device 122 to access web pages in communication network 100. Device 122 includes a browser application 124. There may be many more users operating browser applications to access web pages in communication network 100 than are illustrated in FIG. 1.

In this embodiment, communication network 100 further includes a tag server 130 connected to transport network 140, where tag server 130 includes a processing system 132 and a memory 134. Tag server 130 comprises any server, application, database, or system adapted to store, manage, or handle tags that are assigned to network addresses in communication network 100. A tag comprises any alphanumeric string that a user may assign to a network address through his/her browser application. A tag is generally a short name or phrase (e.g., 3 to 10 characters) that is easy for a user to remember and to convey to other users. A network address comprises a network identifier indicating the location of a web page or content page. One example of a network address is an IP address which is a unique 32-bit number indicating the location of a web page. Another example of a network address is a URL.

Through tag server 130, a service provider operating communication network 100 is able to provide a tag assignment service that allows users to subscribe to the service and to assign a tag to a network address. The tag assignment service may be a no-charge service or may be a paid service. In this embodiment, user 110 and user 120 have subscribed to the service.

Assume that user 110 is operating browser application 114. When operating browser application 114, user 110 identifies a network address for a web page that he/she would like to quickly reference at a later time or would like to convey to another user. One problem is that the network address is lengthy, complex, or is otherwise difficult to reproduce or to convey. According to this embodiment, browser application 114 may provide an interface that allows user 110 to assign a tag to this network address so that the network address is easier to retrieve at a later time. Browser application 114 then operates as follows to assign the tag to the network address.

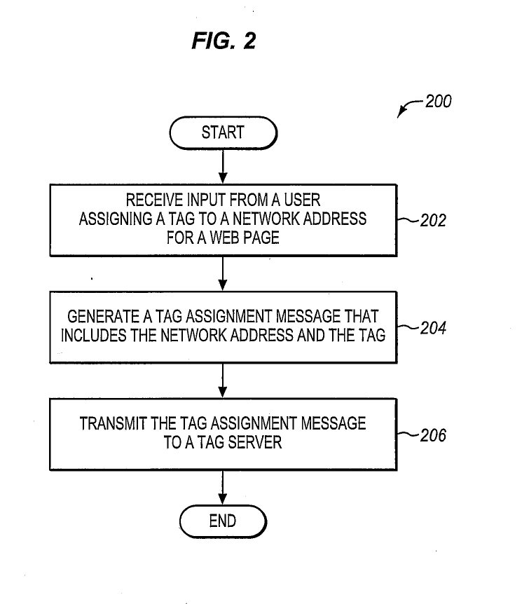

FIG. 2 is a flow chart illustrating a method 200 of operating a browser application to assign a tag to a network address in an exemplary embodiment of the invention. The steps of method 200 will be described with reference to communication network 100 in FIG. 1. The steps of the flow chart in FIG. 2 are not all inclusive and may include other steps not shown.

In step 202 of method 200, browser application 114 receives input from user 110 assigning the tag to the network address for the web page. To receive the input, browser application 114 may display a tag assignment dialog box to allow user 110 to input the tag to assign to the network address. In step 204, browser application 114 generates a tag assignment message that includes the network address and the tag assigned to the network address. The tag assignment message may comprise an HTTP message or a message of another protocol. In step 206, browser application 114 transmits the tag assignment message to tag server 130 for storage of the tag as assigned to the network address. Browser application 114 transmits the tag assignment message over some type of network connection established between browser application 114 and tag server 130.

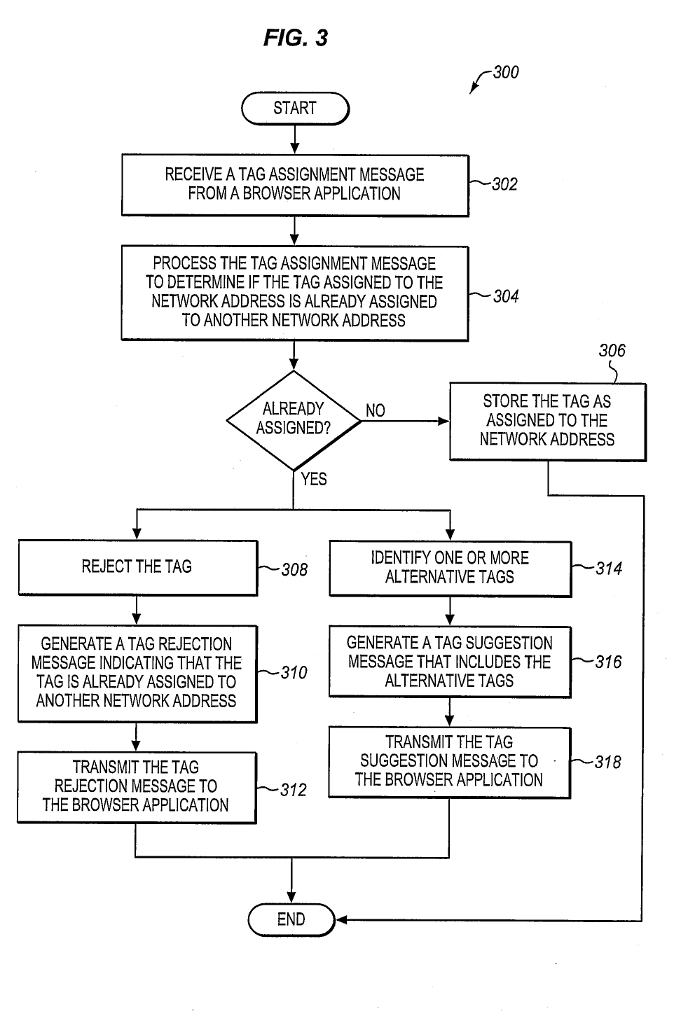

FIG. 3 is a flow chart illustrating a method 300 of operating a tag server to assign a tag to a network address in an exemplary embodiment of the invention. The steps of method 300 will be described with reference to communication network 100 in FIG. 1. The steps of the flow chart in FIG. 3 are not all inclusive and may include other steps not shown.

In step 302 of method 300, processing system 132 receives the tag assignment message from browser application 114 over a network connection. In step 304, processing system 132 processes the tag assignment message to determine if the tag assigned to the network address is already assigned to another network address. Processing system 132 may have already stored one or more tags in memory 134 that are assigned to network addresses. The tags that are already stored in memory 134 may have been assigned by user 110, user 120, or other users not shown in FIG. 1. Thus, processing system 132 determines whether the tag received in the tag assignment message has already been assigned before storing the tag. Processing system 132 may also make other determinations before storing the tag received in the tag assignment message. For instance, processing system 132 may determine whether user 110 is authorized to store tags, whether user 110 has provided payment for storage of the tag if the tag assignment service is a paid service, etc.

If the tag received in the tag assignment message is not already assigned to another network address, then processing system 132 accepts the tag and stores the tag assigned to the network address in memory 134 in step 306. Processing system 132 may also transmit an indication to browser application 114 that the tag was accepted.

Processing system 132 may have pre-defined parameters indicating how long the tag is stored in memory 134. For instance, processing system 132 may store the tag for a default time period, such as one hour, two hours, etc. The time period for storage may depend on a level of service to which user 110 subscribes. If user 110 subscribers to a higher level of service, possibly at a higher charging rate, then the time period may be longer, such as a day, a week, etc. If user 110 subscribers to a lower level of service, possibly at a lower charging rate, then the time period may be shorter, such as one hour, two hours, etc. The tag may also be permanently stored in memory 134. Processing system 132 thus continually monitors the stored tags to identify which tags should remain in storage and which tags should be deleted.

If the tag received in the tag assignment message is already assigned to another network address, then processing system 132 may operate in a variety of ways. In one embodiment, if the tag received in the tag assignment message is already assigned to another network address, then processing system 132 rejects the tag in step 308. If the tag is rejected, then processing system 132 generates a tag rejection message indicating that the tag assigned by user 110 is already assigned to another network address in step 310. In step 312, processing system 132 transmits the tag rejection message to browser application 114 responsive to which the browser application 114 indicates to user 110 that the tag is already assigned. User 110 may then enter a new tag and repeat the processes illustrated in FIGS. 2-3.

In another embodiment, if the tag received in the tag assignment message is already assigned to another network address, then processing system 132 identifies one or more alternative tags that are not already assigned to another network address in step 314. The alternative tags identified by processing system 132 may resemble the tag assigned by user 110. For example, if the tag assigned by user 110 is “JOBS” and that tag is already assigned to another network address, then processing system 132 may identify the alternative tags of “JOBS1”, “JOBS2”, etc. In step 316, processing system 132 generates a tag suggestion message that includes the alternative tags identified by processing system 132. In step 318, processing system 132 transmits the tag suggestion message to browser application 114 for display of the alternative tags to user 110. User 110 may then select one of the alternate tags as suggested by tag server 130, or may enter a new tag and repeat the processes illustrated in FIGS. 2-3.

When a tag is assigned to the network address by user 110 and stored in tag server 130, the network address may be subsequently retrieved by user 110, by user 120, or by another user not shown in FIG. 1. Assume that user 120 is operating browser application 124, and wants to retrieve the network address of the web page. User 110 may somehow convey the tag to user 120, such as by verbally giving user 120 the tag, by emailing user 120 the tag, by transmitting a text message to user 120, etc. According to this embodiment, browser application 124 may provide an interface that allows user 120 to enter a tag and retrieve the network address. Browser application 124 then operates as follows to retrieve the network address assigned to the tag entered by user 120.

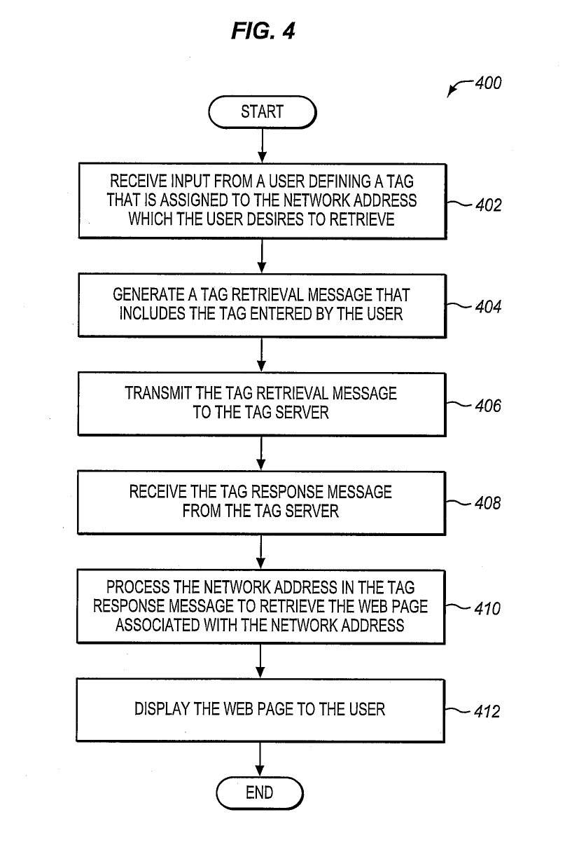

FIG. 4 is a flow chart illustrating a method 400 of operating a browser application to retrieve a network address assigned to a tag in an exemplary embodiment of the invention. The steps of method 400 will be described with reference to communication network 100 in FIG. 1. The steps of the flow chart in FIG. 4 are not all inclusive and may include other steps not shown.

In step 402 of method 400, browser application 124 receives input from user 120 defining a tag that is assigned to the network address which user 120 desires to retrieve. To receive the input, browser application 124 may display a tag retrieval dialog box to allow user 120 to input the tag for the network address to be retrieved. In step 404, browser application 124 generates a tag retrieval message that includes the tag as entered by user 120. The tag retrieval message may comprise an HTTP message or a message of another protocol. In step 406, browser application 124 transmits the tag retrieval message to tag server 130.

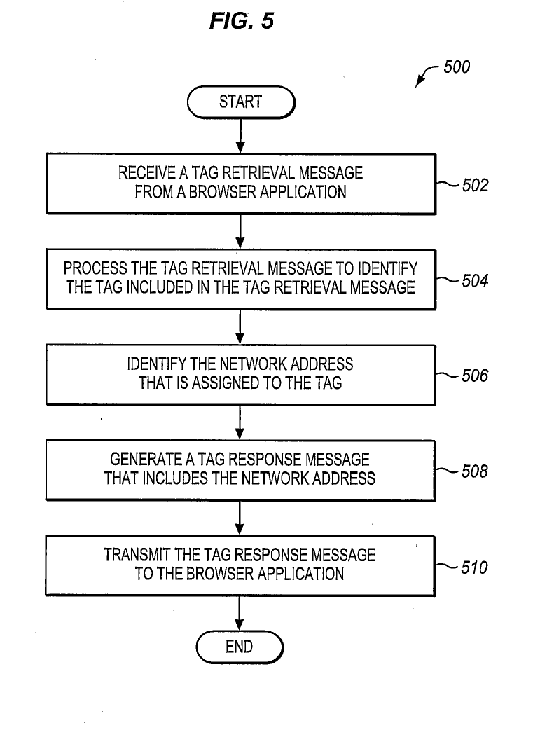

FIG. 5 is a flow chart illustrating a method 500 of operating a tag server to retrieve a network address that is assigned to a tag in an exemplary embodiment of the invention. The steps of method 500 will be described with reference to communication network 100 in FIG. 1. The steps of the flow chart in FIG. 5 are not all inclusive and may include other steps not shown.

In step 502 of method 500, processing system 132 receives the tag retrieval message from browser application 124. In step 504, processing system 132 processes the tag retrieval message to identify the tag included in the tag retrieval message. In step 506, processing system 132 identifies the network address in memory 134 that is assigned to the tag. In step 508, processing system 132 generates a tag response message that includes the network address assigned to the tag. In step 510, processing system 132 transmits the tag response message to browser application 124.

Referring again to method 400 illustrated in FIG. 4, browser application 124 receives the tag response message from tag server 130 in step 408. In step 410, browser application 124 processes the network address in the tag response message to retrieve the web page associated with the network address. For instance, browser application 124 may format an HTTP message or a message of another protocol to query one of content servers 104-106 for the web page associated with the retrieved network address. If the network address comprises a URL, then browser application 124 may query a Domain Name Server (DNS) to translate the URL to an IP address. When the web page is retrieved, browser application 124 displays the web page to user 120 in step 412.

The above methods advantageously allow user 110 to assign a short, easy to remember tag to a lengthy and complex network address. The tag assigned by user 110 is stored in tag server 130 so that the network address may be subsequently retrieved. At some later time, user 110 may retrieve the network address from tag server 130 by simply entering the tag into a browser application. Also, user 110 may convey the tag to user 120 so that user 120 may also retrieve the network address from tag server 130 by simply entering the tag into his/her browser application. The assignment of tags greatly simplifies the process of accessing web pages and navigating the Internet.

### EXAMPLE

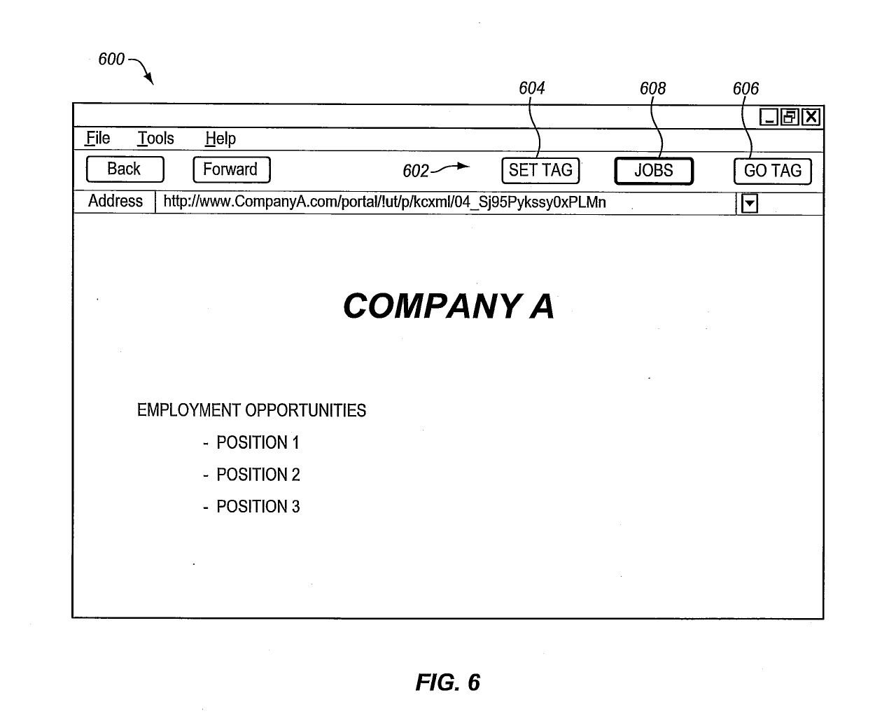

The following illustrates an example of assigning a tag to a network address of a web page. FIG. 6 illustrates the browser interface of a browser application for assigning a tag in an exemplary embodiment of the invention. Assume again that user 110 is operating browser application 114, and browser application 114 displays the browser interface 600 illustrated in FIG. 6. In addition to the traditional drop down menus, back button, forward button, address dialog box, etc, browser interface 600 additionally includes a tag assignment/retrieval interface 602. In this embodiment, tag assignment/retrieval interface 602 includes a “SET TAG” button 604, a “GO TAG” button 606, and a dialog box 608 for entering a tag. The browser interface 600 in other embodiments may have other buttons or dialog boxes than those illustrated in FIG. 6.

User 110 is presently viewing a web page for Company A in FIG. 6 that is advertising jobs. This web page for Company A has a URL of “www.CompanyA.com/portal/!ut/p/kcxml/04_Sj95Pykssy0xPLMn”. If user 110 finds this URL difficult to remember or difficult to convey to another user, then user 110 may enter a tag into dialog box 608 provided by browser application 114. In his embodiment, user 110 enters “JOBS” into dialog box 608, and selects the “SET TAG” button 604. Responsive to the selection of the “SET TAG” button 604, browser application 114 assigns the tag “JOBS” to the URL of Company A presently being viewed by user 110. Browser application 114 may allow user 110 to enter another URL to assign to the tag instead of the URL being presently displayed by browser application 114.

Browser application 114 then generates a tag assignment message that includes the URL for Company A and the tag assigned to the URL, and transmits the tag assignment message to tag server 130 (see FIG. 1). If the tag is not already assigned to another URL, tag server 130 stores the tag “JOBS” as assigned to the URL for Company A. User 110 or other users may then retrieve the URL for Company A by simply entering the tag into their browser application.

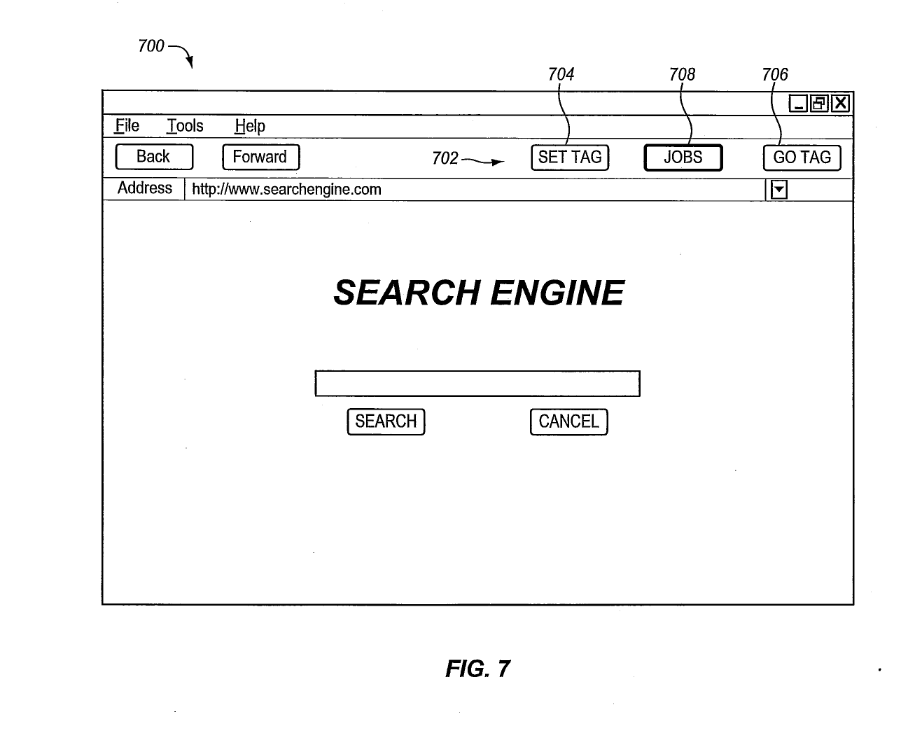

Assume for example that user 110 wants to refer user 120 to the web page for Company A that is advertising jobs. Instead of trying to convey the lengthy and complex URL for the web page, user 110 merely gives user 120 the tag “JOBS”. User 120 may then enter this tag into his/her browser application 124 to retrieve this web page as is illustrated in FIG. 7.

FIG. 7 illustrates the browser interface of a browser application for retrieving a URL in an exemplary embodiment of the invention. As with the browser interface 600 in FIG. 6, browser interface 700 provided by browser application 124 includes a tag assignment/retrieval interface 702 having a “SET TAG” button 704, a “GO TAG” button 706, and a dialog box 708 for entering a tag.

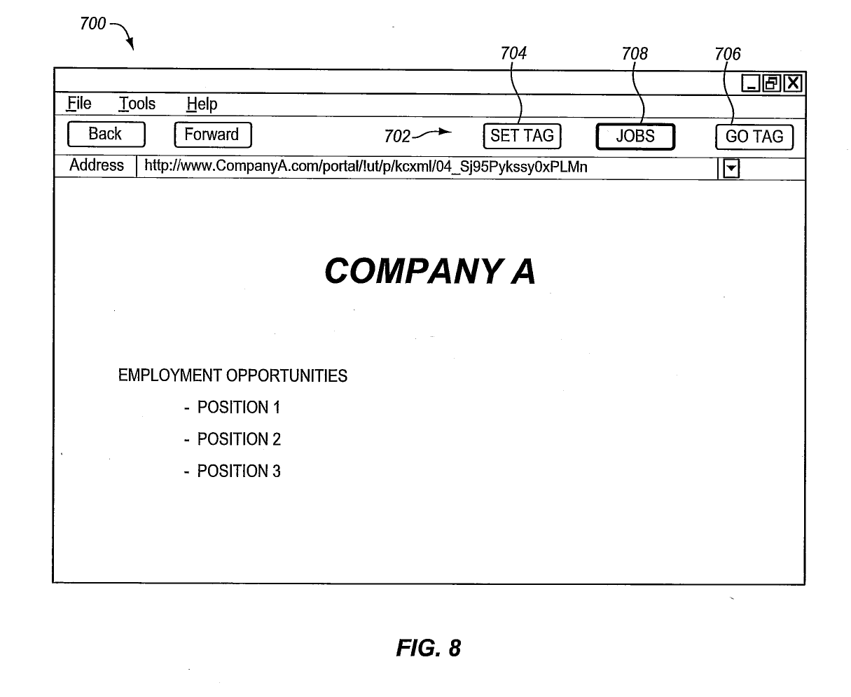

To retrieve the job advertising web page for Company A, user 120 enters the tag “JOBS” into dialog box 708 provided by browser application 124. User 120 then selects the “GO TAG” button 704. Responsive to the selection of the “GO TAG” button 704, browser application 124 generates a tag retrieval message that includes the tag as entered by user 120, and transmits the tag retrieval message to tag server 130 to retrieve the URL assigned to the tag. Responsive to the tag retrieval message, browser application 124 receives a tag response message from tag server 130 that includes the URL for the web page of Company A. Browser application 124 processes the URL in the tag response message to retrieve and display the web page for Company A. FIG. 8 illustrates browser application 124 displaying the web page for Company A in an exemplary embodiment of the invention.

As is illustrated in this example, user 120 merely had to enter the tag of “JOBS” as provided by user 110 to retrieve the web page for Company A. The assignment of the tag to the URL for the web page makes navigating to the web page easier and more convenient for user 120.

Although specific embodiments were described herein, the scope of the invention is not limited to those specific embodiments. The scope of the invention is defined by the following claims and any equivalents thereof.

We claim:

1. A tag system, comprising:
a memory; and
a processing system adapted to receive a tag assignment message from a first browser application over a first network connection, wherein the tag assignment message includes a network address for a web page and includes a tag assigned to the network address by a first user, to process the tag assignment message to determine if the tag assigned to the network address by the first user is assigned to another network address as stored in the memory, and to store the tag assigned to the network address in the memory if the tag is not already assigned to another network address.

2. The tag system of claim 1 wherein if the tag is already assigned to another network address, then the processing system is further adapted to:
reject the tag;
generate a tag rejection message indicating that the tag assigned by the first user is already assigned to another network address; and
transmit the tag rejection message to the first browser application over the first network connection.

3. The tag system of claim 1 wherein if the tag is already assigned to another network address, then the processing system is further adapted to:
identify at least one alternative tag resembling the tag assigned by the first user that is not already assigned to another network address as stored in the memory;
generate a tag suggestion message that includes the at least one alternative tag; and
transmit the tag suggestion message to the first browser application over the first network connection for display of the at least one alternative tag to the first user.

4. The tag system of claim 1 wherein the network address comprises a Universal Resource Locator (URL) for the web page.

5. The tag system of claim 1 where the processing system is further adapted to:
receive a tag retrieval message from a second browser application over a second network connection, wherein the tag retrieval message includes the tag as entered by a second user;
process the tag retrieval message to identify the tag;
identify the network address in the memory that is assigned to the tag;
generate a tag response message that includes the network address assigned to the tag; and
transmit the tag response message to the second browser application over the second network connection.

6. The tag system of claim 1 wherein the processing system is further adapted to delete the tag from the memory after a time period.

7. A method of operating a tag system to store tags that are assigned to network addresses, the method comprising:
receiving a tag assignment message from a first browser application over a first network connection, wherein the tag assignment message includes a network address for a web page and includes a tag assigned to the network address by a first user;
processing the tag assignment message to determine if the tag assigned to the network address by the first user is assigned to another network address; and
storing the tag assigned to the network address if the tag is not already assigned to another network address.

8. The method of claim 7 wherein if the tag is already assigned to another network address, then the method further comprises:
rejecting the tag;
generating a tag rejection message indicating that the tag assigned by the first user is already assigned to another network address; and
transmitting the tag rejection message to the first browser application over the first network connection.

9. The method of claim 7 wherein if the tag is already assigned to another network address, then the method further comprises:
identifying at least one alternative tag resembling the tag assigned by the first user that is not already assigned to another network address;
generating a tag suggestion message that includes the at least one alternative tag; and
transmitting the tag suggestion message to the first browser application over the first network connection for display of the at least one alternative tag to the first user.

10. The method of claim 7 wherein the network address comprises a Universal Resource Locator (URL) for the web page.

11. The method of claim 7 further comprising:
receiving a tag retrieval message from a second browser application over a second network connection, wherein the tag retrieval message includes the tag as entered by a second user;
processing the tag retrieval message to identify the tag;
identifying the network address in the memory that is assigned to the tag;
generating a tag response message that includes the network address assigned to the tag; and
transmitting the tag response message to the second browser application over the second network connection.

12. The method of claim 7 further comprising deleting the tag after a time period.

13. A method of operating a browser application, the method comprising:
receiving input from a user assigning a tag to a network address for a web page;
generating a tag assignment message that includes the network address and the tag assigned to the network address; and
transmitting the tag assignment message to a tag server over a network connection for storage of the tag as assigned to the network address.

14. The method of claim 13 wherein the network address comprises a Universal Resource Locator (URL) for the web page.

15. The method of claim 13 wherein the network address for the web page comprises the network address of the web page presently being displayed by the browser application.

16. The method of claim 13 further comprising:
displaying a tag assignment dialog box to allow the user to input the tag to assign to the network address.

17. The method of claim 13 further comprising:
receiving input from the user or another user requesting the network address assigned to the tag;
generating a tag retrieval message that includes the tag; and
transmitting the tag retrieval message to the tag server over the network connection to retrieve the network address from the tag server that was assigned to the tag.

18. The method of claim 17 further comprising:
receiving a tag response message from the tag server over the network connection, wherein the tag response message includes the network address assigned to the tag;
processing the network address in the tag response message to retrieve the web page associated with the network address; and
displaying the web page to the user.

19. The method of claim 17 further comprising:
displaying a tag retrieval dialog box to allow the user or another user to input the tag for the network address desired to be retrieved.
